(19) United States
(12) Patent Application Publication
(10) Pub. No.: US 2014/0049733 A1
(43) Pub. Date: Feb. 20, 2014

(54) LIQUID CRYSTAL DISPLAY APPARATUS

(71) Applicant: BOE TECHNOLOGY GROUP CO., LTD., Beijing (CN)

(72) Inventor: Teruaki Suzuki, Beijing (CN)

(73) Assignee: BOE TECHNOLOGY GROUP CO., LTD., Beijing (CN)

(21) Appl. No.: 13/980,490

(22) PCT Filed: Mar. 12, 2013
(86) PCT No.: PCT/CN2013/072500

§ 371 Date: Jul. 18, 2013

(30) Foreign Application Priority Data
Jun. 1, 2012 (CN) 201220258117.6

(51) Int. Cl. G02F 1/1335

(52) U.S. Cl. CPC G02F 1/133536; G02F 1/133514
USPC 349/96; 349/106

(57) ABSTRACT

A liquid crystal display apparatus is provided. The liquid crystal display apparatus comprises: a display unit (2), a backlight source (29), and a reflection type polarizer (28) disposed between the display unit (2) and the backlight source (29).

### TECHNICAL FIELD

Embodiments of the present invention relate to a liquid crystal display apparatus.

### BACKGROUND

As shown in FIG. 1, a conventional liquid crystal display apparatus mainly comprises: an array substrate (that is, a TFT substrate) 15; a lower polarizer 16, which is disposed below the array substrate 15 and is an absorption type polarizer; an opposite substrate 12, disposed opposite to the array substrate 15; an upper polarizer 11, which is disposed above the opposite substrate 12 and is an absorption type polarizer; a color filter film 13, disposed below the opposite substrate 12; a liquid crystal layer 14, filled between the color filter layer 13 and the array substrate 15; and a backlight source 17, disposed below the lower polarizer 16. The color filter layer 13 is a pigment type color filter layer. The color filter layer 13 comprises sub-pixels 132, 133 and 134 (for example, the sub-pixels 132, 133 and 134 respectively are red sub-pixel, green sub-pixel and blue sub-pixel), and a black matrix 131 is disposed between the adjacent sub-pixels.

The light emitted by the backlight source 17 enters the liquid crystal layer 14 through the absorption type lower polarizer 16 and the array substrate 15, and is modulated by the liquid crystal layer 14 while passing through the liquid crystal layer 14, and finally is emitted to a displaying side of the liquid crystal apparatus through the color filter layer 13, the opposite substrate 12 and the absorption type upper polarizer 11.

In the above display apparatus, since all of the lower polarizer 16, the upper polarizer 11 and the color filter layer 13 absorb the light from the backlight source 17, it is difficult for the display apparatus to achieve a desired brightness.

### SUMMARY

According to one aspect of the present invention, there is provided a liquid crystal display apparatus. The liquid crystal display apparatus comprises: a display unit, a backlight source, and a reflection type polarizer disposed between the display unit and the backlight source.

According to another aspect of the present invention, there is provided a liquid crystal display apparatus. The liquid crystal display apparatus comprises: a display unit, a backlight source, and a reflection type color filter layer disposed between the display unit and the backlight source.

### BRIEF DESCRIPTION OF DRAWINGS

In order to describe the technical solutions of the embodiments of the present invention more clearly, it will give a brief description to the figures of the embodiments below. Obviously, the below described figures are only relate some embodiments of the present invention, and not intended to restrict the present invention.

FIG. 1 is a structural schematic view of a conventional liquid crystal display apparatus;

FIG. 2 is a structural schematic view of a liquid crystal display apparatus according to an embodiment of the present invention; and

FIG. 3 is another structural schematic view of a liquid crystal display apparatus according to an embodiment of the present invention.

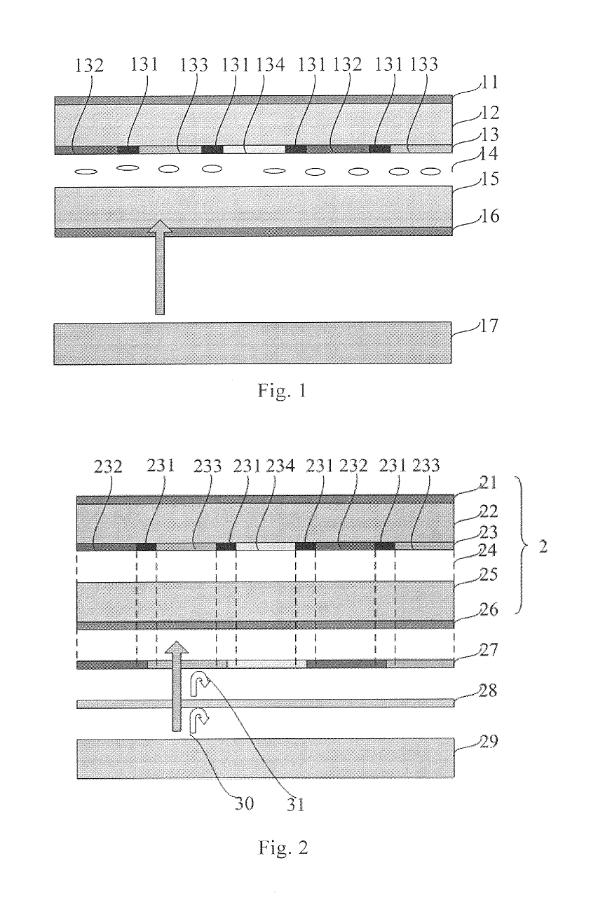

### DETAILED DESCRIPTION

In order to make aims, technical solution and advantages of the embodiments of the present invention to be clearer, the technical solutions of the embodiments of the present invention will be described below clearly and fully in connection with the figures of the embodiments of the present invention. Obviously, the described embodiments are a portion of the embodiments of the present invention, not to be all embodiments. Based on the described embodiments of the present invention, all additional embodiments, which could be obtained by those skilled in the art without paying creative work, belong to the scope of the protection of the present invention.

FIG. 2 is a structural schematic view of a liquid crystal display apparatus according to an embodiment of the present invention. As shown in FIG. 2, the liquid crystal display apparatus according to the embodiment of the present invention comprises: a display unit 2, a backlight source 29, and a reflection type polarizer 28 disposed between the display unit 2 and the backlight source 29.

As shown in FIG. 2, the display unit 2 comprises: an array substrate 25; an opposite substrate 22, disposed opposite to the array substrate 25; an absorption type upper polarizer 21, disposed above the opposite substrate 22; a pigment type color filter layer 23, disposed below the opposite substrate 22; a liquid crystal layer 24, filled between the pigment type color filter layer 23 and the array substrate 25; and an absorption type lower polarizer 26, disposed below the array substrate 15.

As shown in FIG. 2, the backlight source 29 is disposed below the absorption type lower polarizer 26 of the display unit 2, and the reflection type polarizer 28 is disposed between the absorption type lower polarizer 26 and the backlight source 29. The light emitted by the backlight source 29 is incident to the reflection type polarizer 28. A portion of the incident light is reflected by the reflection type polarizer 28 to obtain the reflected light 30, and the other portion of the incident light passes through the reflection type polarizer 28. The reflected light 30 returns back to the backlight source 29 and recycles, and thus the brightness of the LCD can be increased.

As shown in FIG. 2, the liquid crystal display apparatus according to the embodiment of the present invention may further comprise a reflection type color filter layer 27. which is disposed between the display unit 2 (specifically, the absorption type lower polarizer 26 of the display unit 2) and the reflection type polarizer 28. Referring to FIG. 2, the light having passed through the reflection type polarizer 28 is further incident to the reflection type color filter layer 27, and a portion of the incident light is reflected by the reflection type color filter layer 27 to obtain a reflected color light, and the other portion of the incident light passes through the reflection type color filter layer 27 to be used as light for displaying. For example, as to the blue sub-pixel, the reflection type color filter layer 27 makes the blue light to pass through, and reflects light of other colors such as red light and green light. These light reflected by the reflection type color filter layer 27 are scattered to the backlight source 29 or other units, and these scattered light may be utilized again by the sub-pixels such as green sub-pixel or red sub-pixel, so that the brightness of the LCD can be increased and the viewing angle can be widened.

In the structure shown in FIG. 2, the pigment type color filter layer 23 comprises sub-pixels 232, 233 and 234, and a black matrix 231 is disposed between the adjacent sub-pixels. The reflection type color filter layer 27 is disposed to align with the pigment type color filter layer 23, so that the pixel pattern of the reflection type color filter layer 27 and the pixel pattern of the pigment type color filter layer 23 are identical to each other. According to the detailed arrangement of the pixel pattern, the color light obtained by the reflection by the reflection type color filter layer 27 may comprise red, green, blue, cyan, magenta or yellow colors, and the number of the color light may be two or three, or more.

In the structure shown in FIG. 2, the reflection type polarizer 28 may be a polarizer having cholesteric liquid crystal, a multi-layer reflection type polarizer or a wire grid polarizer. The array substrate 25 may be manufactured by a thin glass substrate having a thickness smaller than a predetermined threshold value.

In the structure shown in FIG. 2, the pigment type color filter layer 23 is formed on the opposite substrate 22. However, the pigment type color filter layer 23 may also be formed on the array substrate 25. For example, the pigment type color filter layer 23 may be disposed on the upper surface of the array substrate 25, and in such case, the liquid crystal layer 14 is filled between the opposite substrate 22 and the pigment type color filter layer 23.

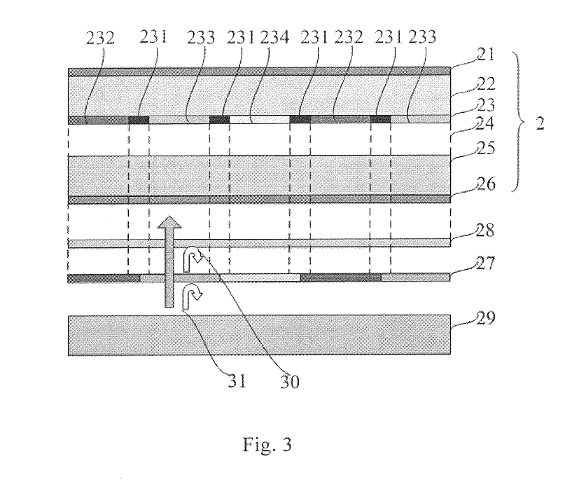

FIG. 3 is another structural schematic view of a liquid crystal display apparatus according to an embodiment of the present invention. The structure shown in FIG. 3 is different from the structure shown in FIG. 2 in that: the reflection type color filter layer 27 is disposed between the reflection type polarizer 28 and the backlight source 29. The other parts of the structure shown in FIG. 3 are the same as those of FIG. 2, and their detailed descriptions are omitted here for simplicity.

In the structure shown in FIG. 3, the light emitted by the backlight source 29 is firstly incident to the reflection type color filter layer 27, and a portion of the incident light is reflected by the reflection type color filter layer 27 to obtain the reflected color light, and the other portion of the incident light passes through the reflection type color filter layer 27. The light having passed through the reflection type color filter layer 27 is further incident to the reflection type polarizer 28, and a portion of the incident light is reflected by the reflection type polarizer 28 to obtain the reflected light 30, and the other portion of the incident light passes through the reflection type polarizer 28 to be used as light for displaying. The reflected color light and the reflected light 30 described above reach the backlight source 29 or other units and recycle, so that the brightness of the LCD can be increased.

The foregoing embodiments merely are exemplary embodiments of the invention, and not intended to define the scope of the invention, and the scope of the invention is determined by the appended claims.

What is claimed is:

1. A liquid crystal display apparatus, comprising: a display unit, a backlight source, and a reflection type polarizer disposed between the display unit and the backlight source.

2. The liquid crystal display apparatus according to claim 1, wherein the liquid crystal display apparatus further comprises a reflection type color filter layer, and the display unit comprises a pigment type color filter layer, and the reflection type color filter layer and the pigment type color filter layer are disposed to align with each other.

3. The liquid crystal display apparatus according to claim 2, wherein the reflection type color filter layer is disposed between the display unit and the reflection type polarizer.

4. The liquid crystal display apparatus according to claim 2, wherein the reflection type color filter layer is disposed between the reflection type polarizer and the backlight source.

5. The liquid crystal display apparatus according to claim 2, wherein the pigment type color filter layer comprises sub-pixels, and a black matrix is disposed between adjacent sub-pixels.

6. The liquid crystal display apparatus according to claim 2, wherein the display unit further comprises an array substrate and an opposite substrate which is disposed opposite to the array substrate, and the pigment type color filter layer is disposed on the array substrate or the opposite substrate.

7. The liquid crystal display apparatus according to claim 1, wherein the reflection type polarizer is a polarizer having cholesteric liquid crystal, a multi-layer reflection type polarizer or a wire grid polarizer.

8. The liquid crystal display apparatus according to claim 1, wherein the display unit comprises:
an array substrate;
an opposite substrate, disposed opposite to the array substrate;
an absorption type upper polarizer, disposed above the opposite substrate;
a pigment type color filter layer, disposed on the array substrate or the opposite substrate;
a liquid crystal layer, filled between the array substrate and the opposite substrate; and
an absorption type lower polarizer, disposed below the array substrate;

9. The liquid crystal display apparatus according to claim 8, wherein the pigment type color filter layer comprises sub-pixels, and a black matrix is disposed between adjacent sub-pixels.

10. A liquid crystal display apparatus, comprising: a display unit, a backlight source, and a reflection type color filter layer disposed between the display unit and the backlight source.

11. The liquid crystal display apparatus according to claim 10, wherein the liquid crystal display apparatus further comprises a reflection type polarizer.

12. The liquid crystal display apparatus according to claim 11, wherein the reflective polarizer is disposed between the reflection type color filter layer and the backlight source.

13. The liquid crystal display apparatus according to claim 11, wherein the reflective polarizer is disposed between the reflection type color filter layer and the display unit.

14. The liquid crystal display apparatus according to claim 11, wherein the reflection type polarizer is a polarizer having cholesteric liquid crystal, a multi-layer reflection type polarizer or a wire grid polarizer.

15. The liquid crystal display apparatus according to claim 10, wherein the display unit comprises a pigment type color filter layer, and the reflection type color filter layer and the pigment type color filter layer are disposed to align with each other.

16. The liquid crystal display apparatus according to claim 15, wherein the display unit comprise an array substrate and an opposite substrate disposed opposite to the array substrate, and the pigment type color filter layer is disposed on the array substrate or the opposite substrate.
